(19) United States
(12) Patent Application Publication
(10) Pub. No.: US 2025/0370401 A1
(43) Pub. Date: Dec. 4, 2025

(54) IMAGE FORMING APPARATUS

(71) Applicant: KYOCERA Document Solutions Inc., Osaka (JP)

(72) Inventor: Koki YOKOYAMA, Osaka (JP)

(73) Assignee: KYOCERA Document Solutions Inc., Osaka (JP)

(21) Appl. No.: 19/221,394

(22) Filed: May 28, 2025

(30) Foreign Application Priority Data
May 30, 2024 (JP) 2024-087565

(51) Int. Cl. G03G 21/16; G03G 15/00

(52) U.S. Cl. CPC G03G 21/1638; G03G 15/6508; G03G 2215/00552

(57) ABSTRACT

An image forming apparatus includes a first sheet stacking portion, a second sheet stacking portion, an image forming portion, and a sheet feeding portion. A bottom part of a feeding passage connecting between the second sheet stacking portion and the sheet feeding portion is configured with a conveyance guide movable up and down. The conveyance guide includes a tray body portion in the shape of a flat plate and a handle portion. With the first sheet stacking portion mounted in the apparatus body, the tray body portion is held on the apparatus body above the first sheet stacking portion. The handle portion protrudes from an upstream end part of the tray body portion in the sheet conveyance direction and is pivotable in the up-down direction.

This application is based on and claims the benefit of priority from Japanese Patent Application No. 2024-087565 filed on May 30, 2024, the contents of which are hereby incorporated by reference.

### BACKGROUND

The present disclosure relates to an image forming apparatus.

A conventional image forming apparatus includes a first sheet stacking portion, a second sheet stacking portion, an image forming portion, and a sheet feeding portion. The first sheet stacking portion is movable up and down, has a lift portion on which sheets are stacked, and is removably mounted in the apparatus body. The second sheet stacking portion is connected to outside the apparatus body and is stacked with sheets inserted by the user. The image forming portion records an image formed based on image data to a sheet. The sheet feeding portion feeds the sheet from the first or second sheet stacking portion to the image forming portion. A bottom part of a feeding passage connecting between the second sheet stacking portion and the sheet feeding portion is configured with a conveyance guide.

When a sheet jam occurs in the apparatus body and has to be removed, the first sheet stacking portion is pulled out of the apparatus body. Thus, the jammed sheet can be removed with fingers extended into the apparatus body through an open part of it.

With conventional technology, when the conveyance guide is lowered, it can block the open part of the apparatus body and thus the fingers may not reach into the back of the apparatus body. This makes jam removal difficult.

An object of the present disclosure is to provide an image forming apparatus that allows easier jam removal.

### SUMMARY

To achieve the above object, according to one configuration of the present disclosure, an image forming apparatus includes a first sheet stacking portion, a second sheet stacking portion, an image forming portion, and a sheet feeding portion. The first sheet stacking portion is movable up and down, has a lift portion on which sheets are stacked, and is removably mounted in the apparatus body. The second sheet stacking portion is connected to outside the apparatus body and is stacked with sheets inserted by the user. The image forming portion records an image formed based on image data to a sheet. The sheet feeding portion feeds the sheet from the first or second sheet stacking portion to the image forming portion. A bottom part of a feeding passage connecting between the second sheet stacking portion and the sheet feeding portion is configured with a conveyance guide that is movable up and down. The conveyance guide includes a tray body portion in the shape of a flat plate and a handle portion. With the first sheet stacking portion mounted in the apparatus body, the tray body portion is held on the apparatus body above the first sheet stacking portion. The handle portion protrudes from an upstream end part of the tray body portion in the sheet conveyance direction and is pivotable in the up-down direction.

The other objects of the present disclosure and the specific advantages that can be gained from the present disclosure will be made clearer through the description of the embodiments provided below.

### BRIEF DESCRIPTION OF THE DRAWINGS

FIG. 1 is a schematic sectional view showing the internal construction of an image forming apparatus 100 according to an embodiment of the present disclosure.

FIG. 2 is an enlarged side sectional view around a lower part of the image forming apparatus 100.

FIG. 3 is a top view of a conveyance guide 50 in the image forming apparatus 100 according to the embodiment of the present disclosure.

FIG. 4 is a side view of the conveyance guide 50 in the image forming apparatus 100 according to the embodiment of the present disclosure.

FIG. 5 is an enlarged side view around a lower part of the image forming apparatus 100.

FIG. 6 is an enlarged side view around a lower part of the image forming apparatus 100.

FIG. 7 is an enlarged side view of an upper end part of a guide groove portion 71a in the image forming apparatus 100.

### DETAILED DESCRIPTION

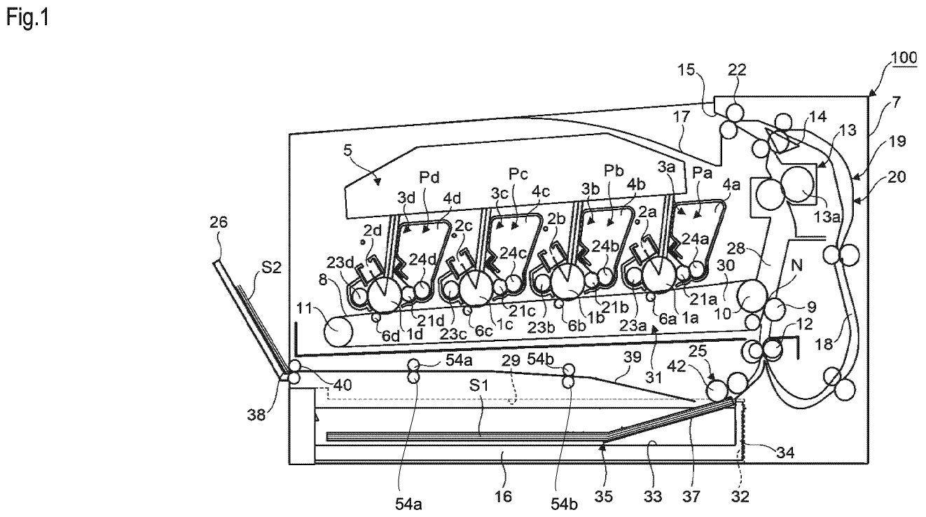

A first embodiment of the present disclosure will be described below with reference to the accompanying drawings. FIG. 1 is a schematic sectional view showing the internal construction of an image forming apparatus 100 according to an embodiment of the present disclosure. The image forming apparatus 100 shown in FIG. 1 is what is called a tandem-type color printer.

The image forming apparatus 100 includes image forming portions Pa to Pd. The image forming portions Pa to Pd are disposed inside a main body (hereinafter referred to as the apparatus body 7) of the image forming apparatus 100 and record images formed based on image data to sheets S1 and S2. In this embodiment, the image forming portions Pa to Pd are provided side by side in the horizontal direction. The image forming portions Pa to Pd sequentially form a magenta, a cyan, a yellow, and a black image respectively, each through the processes of electrostatic charging, exposure to light, image development, and image transfer processes. The image forming portions Pa to Pd are provided to correspond to the images of the different colors respectively. The following description focuses on the image forming portion Pa; for the image forming portions Pb to Pd, which are structured similarly to it, no separate description will be given.

The image forming portion Pa has a photosensitive drum 1a, an exposure device 5, a charging device 2a, a developing device 3a, and a rubbing roller 23a. The photosensitive drum 1a carries a visible image (toner image). The exposure device 5 is disposed above the image forming portion Pa and emits a light beam toward the surface of the photoconductor drum 1a to 1d to form an electrostatic latent image. The charging device 2a, the developing device 3a, and the rubbing roller 23a are arranged around the photosensitive drum 1a along the drum rotation direction (clockwise in FIG. 1).

The charging device 2a is disposed opposite the photoconductor drum 1a and can electrostatically charge the surface of the photosensitive drum 1a.

The developer 3a has a developer container 4a, a developing roller 21a, and a feed roller 24a. The developer container 4a is loaded with a predetermined amount of toner. The developer containers 4a to 4d are loaded with magenta, cyan, yellow, and black tonner respectively for the developing devices 3a to 3d. The developing roller 21a is disposed opposite the photosensitive drum 1a. The feed roller 24a feeds the toner in the developer container 4a to the outer circumferential surface of the developing roller 21a. The developing roller 21a can feed the toner supplied to its outer circumference to the photosensitive drum 1a.

The intermediate transfer unit 31 is disposed below the photosensitive drum 1a to 1d. The intermediate transfer unit 31 has a frame 30, a driving roller 10, a tension roller 11, an intermediate transfer belt 8, and primary transfer rollers 6a to 6d.

The frame 30 extends along the width direction of the image forming apparatus 100 (the left-right direction in FIG. 1). The driving roller 10 and the tension roller 11 are rotatably supported at the opposite ends of the frame 30 in its longitudinal direction.

The intermediate transfer belt 8 is an endless belt (preferably a seamless belt with no seams). The intermediate transfer belt 8 is stretched from the tension roller 11 to the driving roller 10 so as to be rotatable in the circumferential direction.

The driving roller 10 is connected to a belt driving motor (not shown). When the driving roller 10 rotates with the rotary driving force of the belt driving motor, by a friction force, the rotational driving force is transmitted to the intermediate transfer belt 8. As a result, the intermediate transfer belt 8 rotates in the same direction as the rotation direction of the driving roller 10.

The primary transfer rollers 6a to 6d are supported on the frame 30 so as to be rotatable and movable relative to it, at positions opposite the photosensitive drum 1a to 1d across the intermediate transfer belt 8.

The secondary transfer roller 9 is disposed opposite the driving roller 10 across the intermediate transfer belt 8. The secondary transfer roller 9 is kept in pressed contact with the intermediate transfer belt 8 to form a secondary transfer nip N. The secondary transfer roller 9 secondarily transfers the tonner images formed on the intermediate transfer belt 8 to a sheet S1 or S2 that passes through the secondary transfer nip N.

The image forming apparatus 100 further includes a sheet conveyance passage 20, a pair of registration rollers 12, a sheet cassette 16 (first sheet stacking portion), a sheet feed portion 25, an MPF (multi paper feeder) tray 26 (second sheet stacking portion), and a conveyance guide 50.

The sheet conveyance passage 20 includes a main conveyance passage 28 and a duplex conveyance passage 18. The main conveyance passage 28 extends in the up-down direction. Midway along the main conveyance passage 28 are disposed the pair of registration rollers 12, the secondary transfer roller 9, and a fixing device 13. The main conveyance passage 28 conveys the sheet S1 or S2 from an MPF tray 26, which will be described later, or the sheet cassette 16 such that the sheet passes through the pair of registration rollers 12, the secondary transfer nip N, and the fixing device 13 in this order.

The pair of registration rollers 12 aligns the conveyance direction of the sheet S1 or S2 such that its leading end (a downstream end part of it with respect to the sheet conveyance direction) is orthogonal to the sheet conveyance direction and thereby corrects slanted conveyance (skew).

In a downstream end part of the main conveyance passage 28 with respect to the sheet conveyance direction, a sheet discharge port 15 is provided that leads to outside the image forming apparatus 100. The sheet discharge port 15 is provided with a pair of discharge rollers.

Between the pair of discharge rollers 22 and the fixing device 13 with respect to the sheet conveyance direction, a branch portion 14 is provided. The duplex conveyance passage 18 branches off the main conveyance passage 28 at a position where it overlaps with the branch portion 14 of the main conveyance passage 28 with respect to the sheet conveyance direction and re-joins the main conveyance passage 28 at a position upstream of the pair of registration rollers 12. The branch portion 14 can distribute the sheet S1 or S2 having passed through the fixing device 13 to the sheet discharge port 15 or to the duplex conveyance passage 18.

The sheet cassette 16 and the MPF tray 26 are provided upstream of the main conveyance passage 28 with respect to the sheet conveyance direction. The sheet cassette (first sheet stacking portion) 16 is provided movably up and down, has a lift portion 35 on which the sheet S1 is stacked, and is removably mounted in the apparatus body 7. The MPF tray (second sheet stacking portion) 26 is connected to outside the apparatus body 7 and is stacked with sheets S2 that are inserted by the user.

The sheet feed portion 25 is disposed between, at one side, the main conveyance passage 28 and, at the other side, the sheet cassette 16 and the MPF tray 26, and feeds the sheet S1 from the sheet cassette (first sheet stacking portion) 16 or the sheet from S the MPF tray 26 (second sheet stacking portion) 26 to the image forming portions Pa to Pd. The sheet cassette (first sheet stacking portion) 16, the MPF tray (second sheet stacking portion) 26, and the feeding of sheets S1 and S2 will be described in detail later.

Next, a description will be given of an image forming procedure on the image forming apparatus 100. When a user enters an instruction to start image formation, first, while the photosensitive drum 1a is rotated, the charging devices 2a to 2d electrostatically charge the surfaces of the photosensitive drum 1a to 1d uniformly. Next, the exposure device 5 shines light onto the surfaces of the photosensitive drum 1a to 1d so that electrostatic latent images according to an image signal are formed on the photosensitive drum 1a to 1d.

Subsequently, the toner in the development device 3a to 3d is fed to the photosensitive drum 1a to 1d by the developing rollers 21a to 21d and electrostatically attaches to them. Thus, toner images according to the electrostatic latent images are formed on the photosensitive drum 1a to 1d.

Now, the driving roller 10 is rotated so that the intermediate transfer belt 8 starts to rotate counter-clockwise. The toner images of the different colors formed on the photosensitive drum 1a to 1d are then primarily transferred, one after the next, to the intermediate transfer belt 8.

Thereafter, with predetermined timing, a sheet S1 or S2 is fed from the sheet cassette 16 or the MPF tray 26 to the main conveyance passage 28, passes through the pair of registration rollers 12, and is conveyed to the secondary transfer nip N. The toner images on the intermediate transfer belt 8 are then secondarily transferred to the sheet S1 or S2. The sheet S1 or S2 is then conveyed to the fixing device 13 so that the toner images are heated and pressed by a pair of fixing rollers 13a in the fixing device 13 to be fixed to the surface of the sheet S1 or S2.

Here, in a case where the sheet S1 or S2 is subjected to simplex printing, the branch portion 14 distributes the sheet S1 or S2 having passed through the fixing device 13 to the sheet discharge port 15. The sheet S1 or S2 having reached the sheet discharge port 15 is discharged onto a sheet discharge tray 17 by the pair of discharge rollers 22.

When the sheet S1 or S2 is subjected to duplex printing, the branch portion 14 distributes the sheet S1 or S2 having passed through the fixing device 13 to the duplex conveyance passage 18. The duplex conveyance passage 18 conveys the sheet S1 or S2, while reversing it top side down, once again to the pair of registration rollers 12. The sheet S1 or S2 passes through the secondary transfer nip N and the fixing device 13 once again so that tonner images are fixed to its reverse side and is then distributed to the sheet discharge port 15 by the branch portion 14.

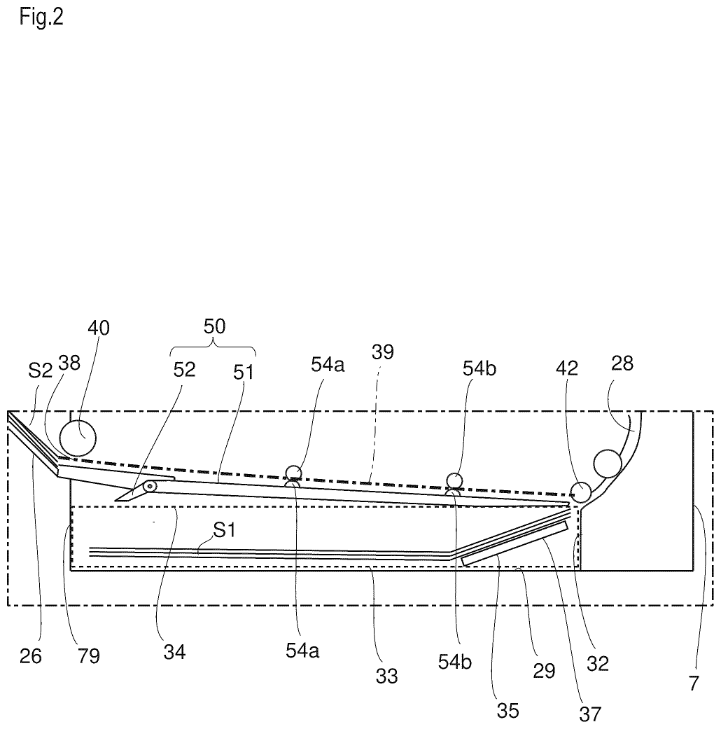

Next, the feeding of the sheet S1 or S2 will be described in detail. FIG. 2 is an enlarged side sectional view around a lower part of the image forming apparatus 100. In FIG. 2, the sheet cassette 16 is indicated by dashed lines and the feed passage 39 is indicated by a dash-and-dot line. In the lower part of the apparatus body 7, a cassette housing portion 29 is formed that is recessed along the horizontal direction. The cassette housing portion 29 is a recessed part that is open (not illustrated) in a side part of the apparatus body 7 and that extends from the edge of the opening portion 79 in the apparatus body 7 in the horizontal direction. In an innermost part of the cassette housing portion 29 with respect to the horizontal direction, an opposite wall portion 32 is provided that rises vertically.

In the cassette housing portion 29, the sheet cassette 16 is housed. The sheet cassette 16 is inserted into the cassette housing portion 29 through the opening in the side part of the apparatus body 7. The sheet cassette 16 is removably mounted in the apparatus body 7; specifically, it can be pulled out of the apparatus body 7 from a position (mounted state) where it is inserted up to the innermost part of the cassette housing portion 29 with respect to the horizonal direction. In the following description, the direction in which the sheet cassette 16 is inserted into the cassette housing portion 29 to be mounted in the apparatus body 7 (i.e., the rightward direction along the horizontal direction in FIG. 2) will be referred to simply as the “mounting direction”.

The sheet cassette 16 has a bottom portion 33, a circumferential wall portion 34, and a lift portion 35. The bottom portion 33 is a flat plate in a rectangular shape that extends in the horizontal direction and constitutes a bottom part of the sheet cassette 16. On the bottom portion 33, sheets S1 are stacked (sheets as a recording medium, such as printing sheets, envelopes, and OHP sheets).

The circumferential wall portion 34 rises vertically from the bottom portion 33 and surrounds the bottom portion 33. With the seat cassette 16 mounted in the apparatus body 7, the circumferential wall portion 34 faces the opposite wall portion 32 with respect to the mounting direction.

The lift portion 35 includes a support portion (not shown) and a stacking plate 37 (see FIG. 1). The support portion 36 is pivotably supported on the circumferential wall portion 34. The stacking plate 37 is a plate-form member on the upper surface of which a sheet S1 can be stacked. The stacking plate 37 is formed integrally with the support portion. As the support portion pivots, the stacking plate 37 moves up and down with respect to the bottom portion 33. In this embodiment, the stacking plate 37 is located downstream (at right in FIG. 1) of the middle of the bottom portion 33 with respect to the sheet conveyance direction. As the stacking plate 37 moves up and down with respect to the bottom portion 33, a downstream end part of the sheet S1 moves up and down.

An introduction port 38 is formed in a side part of the apparatus body 7, above the opening portion 79. Moreover, as shown in FIGS. 1 and 2, the feed passage 39 is formed inside the apparatus main body 7, at a position between the cassette housing portion 29 and the intermediate transfer unit 31 with respect to the up-down direction.

The feed passage 39 connects between the MPF tray (second sheet stacking portion) 26 and the sheet feed portion 25. A bottom part of the feed passage 39 is constituted by an conveyance guide 50 that can move up and down. The conveyance guide 50 also constitutes a top part of the cassette housing portion 29. A downstream end part of the conveyance guide 50 in the sheet conveyance direction is connected to an upstream end part of the main transport path 28 with the sheet feeder 25 in between. The conveyance guide 50 will be described in detail later.

The MPF tray 26 is mounted on a side part of the apparatus body 7, between the introduction port 38 and the opening portion 79 of the cassette storage portion 29 with respect to the up-down direction. The MPF tray 26 is a tray inclined at a predetermined angle on the upper face of which sheets S2 (sheets as a recording medium such as printing sheets, envelopes, and OHP sheets) can be stacked.

The introduction port 38 is provided with a pair of introduction rollers 40. The pair of introduction rollers 40 makes contact with a downstream end part of the sheet S2 with respect to the sheet conveyance direction. The pair of introduction rollers, by rotating, feeds the sheet S1 to the feed passage 39. Along the feed passage 39, a plurality of pairs of conveyance rollers are disposed at predetermined intervals with respect to the sheet conveyance direction. A pair of conveyance rollers 54a and 54b is a pair of roller members facing each other in the up-down direction with the feed passage 39 between them. The sheet S2 conveyed into the feed passage 39 is conveyed by the pairs of conveyance rollers 54a and 54b to the feed roller 42.

The sheet feed portion 25 includes the feed roller 42. The feed roller 42 is rotatably supported on the apparatus body 7 and rotates with a rotary driving force from an unillustrated driving device.

With the sheet cassette 16 mounted in the apparatus body 7, the feed roller 42 is rotated. Then, as the feed roller 42 rotates, of the sheets S1 placed in a bundle in the sheet cassette 16, the topmost sheet S1 is fed to the main conveyance passage 28.

On the other hand, when the sheet S2 is conveyed through the feed passage 39 up to the sheet feed portion 25, while it is passing over a downstream end part of the conveyance guide 50 in the sheet conveyance direction, a downstream end part of the sheet S2 is lifted by the lift portion 35 to be brought into pressed contact with the feed roller 42. In this state, as the feed roller 42 rotates, the sheet S2 is fed to the main conveyance passage 28.

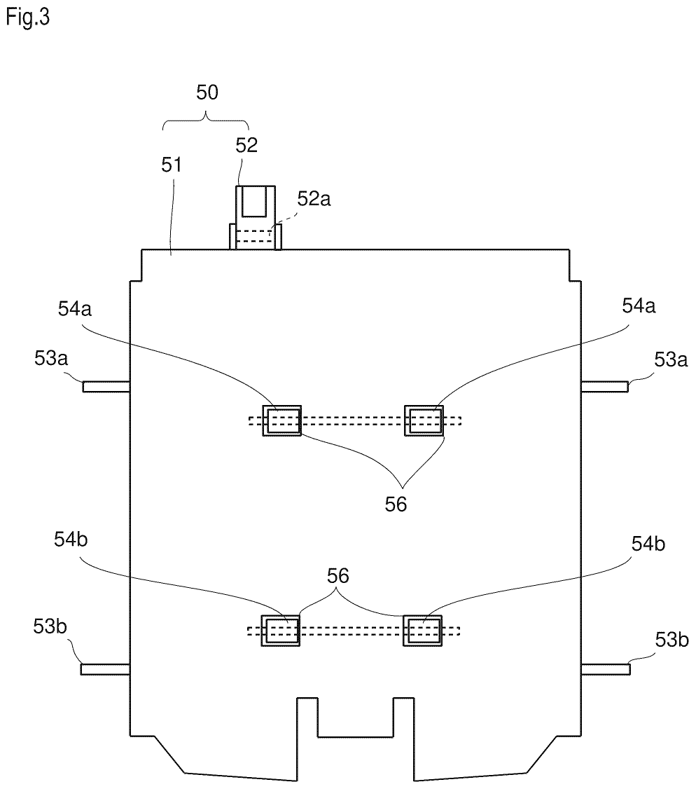

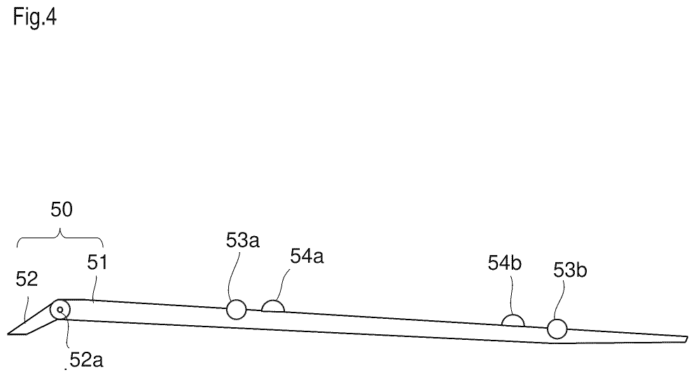

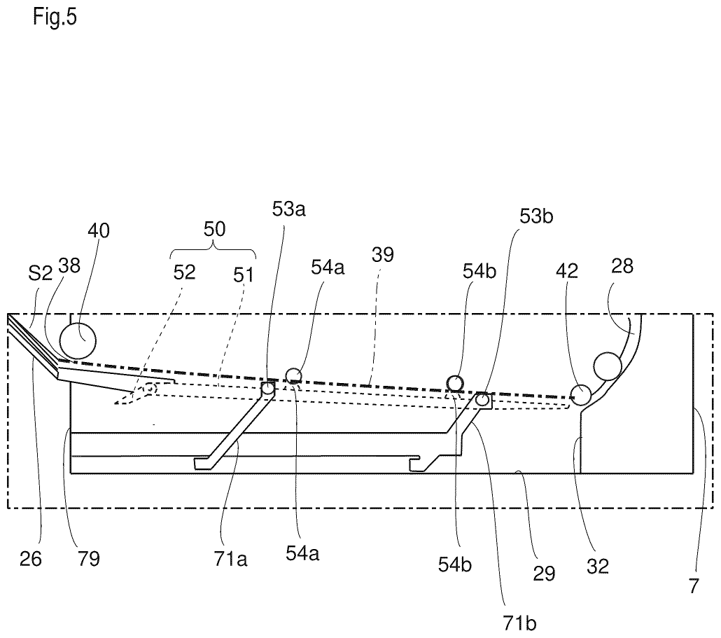

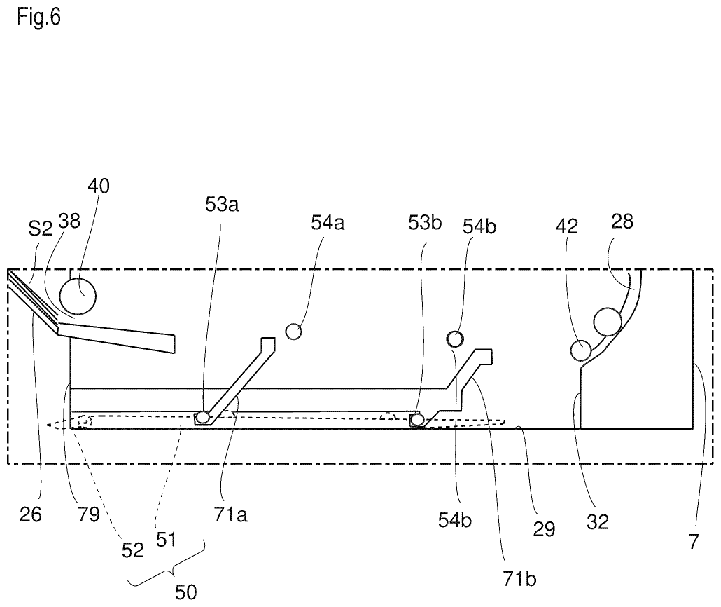

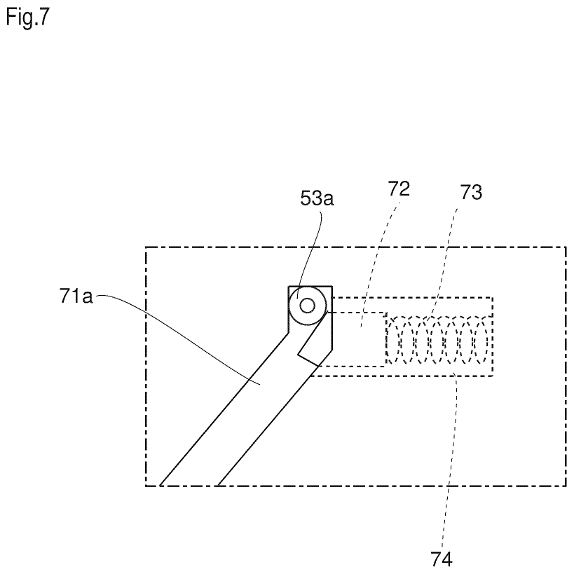

Next, the conveyance guide 50 will be described. FIG. 3 is a top view of the conveyance guide 50, and FIG. 4 is a side view of the conveyance guide 50. FIGS. 5 and 6 are an enlarged side views around a lower part of the image forming apparatus 100, FIG. 5 showing the conveyance guide 50 in an elevated state, FIG. 6 showing the conveyance guide in a lowered state. In FIGS. 5 and 6, the sheet cassette 16 is omitted, and a tray body portion 51 and a handle portion 52 of the conveyance guide 50 are shown by dashed lines. FIG. 7 shows an enlarged side view of an upper end part of a guide groove portion 71a.

The conveyance guide 50 can move up and down and, with the sheet cassette (first sheet stacking portion) 16 mounted in the apparatus body 7, the tray body portion 51 is held on the apparatus body 7, above the sheet cassette (first sheet stacking portion) 16.

The conveyance guide 50 has a plate-form tray body portion 51, a handle portion 52, bosses 53a and 53b and the pair of conveyance rollers 54a and 54b. The tray body portion 51 is formed substantially in a rectangular shape as viewed in a top view. The tray body 51 has four through holes 56 that penetrate it in the up-down direction. The pair of conveyance rollers 54a and 54b are disposed above the through holes 56, respectively. The pair of conveyance rollers 54a and 54b are rotatably supported on the tray body 51.

The handle portion 52 protrudes from an upstream end part of the tray body 51 in the sheet conveyance direction and is pivotable in the up-down direction. More specifically, the handle portion 52 is pivotable around the rotary axis 52a and is urged by an unillustrated spring (first elastic member) so as to be held in a state inclined downward toward upstream in the sheet conveyance direction.

The bosses 53a and 53b protrude from the side faces of the tray body portion 51 in the sheet width direction (crossing direction). The sheet width direction (crossing direction) is a direction orthogonal to the plane of FIGS. 1 and 2. The boss 53a is disposed upstream of the boss 53b in the sheet conveyance direction. When the conveyance guide 50 moves up and down in the up-down direction, the bosses 53a and 53b move in the guide groove portions 71a and 71b, respectively. The guide groove portions 71a and 71b are formed in opposite side faces of the cassette housing portion 29 in the sheet width direction (crossing direction) and extend in the up-down direction. That is, the guide groove portions 71a and 71b are formed in the inner side faces of the apparatus body 7 in the sheet width direction (crossing direction) and extend in the up-down direction 71b.

More specifically, the guide groove portion 71a is disposed upstream of the guide groove portion 71b in the sheet conveyance direction, and the guide groove portions 71a and 71b are inclined downstream in the sheet conveyance direction as they extend upward. An upstream end part of the guide groove portion 71a is provided with a lock portion 72. The lock portion 72 narrows the width of an upstream end part of the guide groove portion 71a, which is urged by a spring (second elastic member) 73. In this embodiment, the spring 73 and the lock portion 72 are disposed in a recess 74 extending from an upstream end part of the guide groove portion 71a downstream in the sheet conveyance direction, and one end of the spring 73 is fixed to an end of the recess 74. The other end of the spring 73 is fixed to the lock portion 72.

When the boss 53a is moved upward along the guide groove section 71a, it contacts the lock portion 72. When the boss 53a is pressed further upward along the guide groove portion 71a, the boss 53a contacts the upper end of the guide groove portion 71a against the urging force of the spring 73. Now, the boss 53a is locked on the lock portion 72. On the other hand, when the boss 53a disposed at the upper end of the guide groove portion 71a is pressed downward, the lock portion 72 moves downstream in the sheet transport direction against the urging force of the spring 73, and the boss 53a is unlocked from the lock portion 72. Thus, the conveyance guide 50 can be easily lowered.

With the sheet cassette (first sheet stacking portion) 16 mounted in the main unit 7, the tray body portion 51 is supported on an upper end part of the circumferential wall portion 34 of the sheet cassette (first sheet stacking portion) 16. Thus, with the sheet cassette (first sheet stacking portion) 16 mounted in the apparatus body 7, the conveyance guide 50 can be stably held on the apparatus body 7.

When a sheet jam occurs in the apparatus body 7 and has to be removed, the user first pulls out the sheet cassette 16 and holds the handle 52 by extending his/her fingers through the opening portion 79 into the apparatus body 7. Next, the user pulls the handle portion 52 downward to lower the conveyance guide 50. Here, the handle portion 52 is tilted downward toward upstream in the sheet conveyance direction and thus the user can easily hold the handle 52. This allows easier jam removal.

On the other hand, when, with the sheet cassette (first sheet stacking portion) 16 pulled out of the apparatus body 7, the tray body portion 51 is lowered to the bottom of the apparatus body 7, the handle portion 52 pivots against the urging force of the spring (first elastic member) and extends flush with the tray body portion 51. Thus, the opening portion 79 of the apparatus main body 7 is prevented from being blocked by the conveyance guide 50. Therefore, the user can extend his/him fingers easily through the opening portion 79 into the apparatus body 7. This allows yet easier jam removal.

The embodiments described above are not meant to limit the scope of the present disclosure, which thus allows for any modifications without departure from the spirit of what is disclosed herein. For example, in the embodiments described above, a color printer as shown in FIG. 1 is used as the image forming apparatus 100. However, what is described above is applicable not only to color printers but also to any other image forming apparatuses such as monochrome and color copiers, digital multifunctional machines, and facsimile machines.

The present disclosure find applications in imaging forming apparatuses that include a charging roller.

What is claimed is:

1. An image forming apparatus comprising:
a first sheet stacking portion that is movable up and down, the first sheet stacking portion having a lift portion on which a sheet is stacked, the first sheet stacking portion being removably mounted in an apparatus body;
a second sheet stacking portion that is connected to outside the apparatus body and that is stacked with a sheet inserted by a user;
an image forming portion that records an image formed based on image data to the sheet; and
a sheet feeding portion that feeds the sheet from the first or second sheet stacking portion to the image forming portion,
wherein
a bottom part of a feeding passage connected between the second sheet stacking portion and the sheet feeding portion being configured with a conveyance guide that is movable up and down, and
the conveyance guide includes:
a tray body portion that, with the first sheet stacking portion mounted in the apparatus body, is held on the apparatus body above the first sheet stacking portion, the tray body portion being in a shape of a flat plate; and
a handle portion that protrudes from an upstream end part of the tray body portion in the sheet conveyance direction, the handle portion being pivotable in an up-down direction.

2. The image forming apparatus according to claim 1, wherein
the handle portion is urged by a first elastic member so as to be held in a state inclined downward toward upstream in the sheet conveyance direction.

3. The image forming apparatus according to claim 2, wherein
When the first sheet stacking portion pulled out of the apparatus body, the tray body is lowered to a bottom part of the apparatus body, the handle pivots against an urging force of the first elastic member and extends flush with the tray body.

4. The image forming apparatus according to claim 1, wherein
the conveyance guide has:
a boss that protrudes from a side face of the tray body portion in a direction crossing the sheet conveyance direction,
the apparatus body further includes a guide groove portion formed on an inner side face thereof in the crossing direction and extending in the up-down direction, and
when the conveyance guide moves up and down in the up-down direction, the boss moves in the guide groove portion.

5. The image forming apparatus according to claim 4, wherein
the apparatus body has a lock portion that is urged by a second elastic member to narrow a width of an upstream end part of the guide groove portion, and
the boss is locked on the lock portion when the boss is disposed in an upstream end part of the guide groove portion.

6. the image forming apparatus according to claim 1, wherein
with the first sheet stacking portion mounted in the main unit, the tray body portion is supported on an upper end part of the first sheet stacking portion.
